(19) United States
(12) Patent Application Publication
(10) Pub. No.: US 2006/0146001 A1
(43) Pub. Date: Jul. 6, 2006

(54) Data line driver including a plurality of cascaded data line driver sections having long sampling period of video signals

(76) Inventor: Tadao Minami, Kanagawa (JP)

Correspondence Address: YOUNG & THOMPSON, 745 SOUTH 23RD STREET, 2ND FLOOR, ARLINGTON, VA, 22202, US

(21) Appl. No.: 11/324,551

(22) Filed: Jan. 4, 2006

(30) Foreign Application Priority Data
Jan. 5, 2005 (JP) 2005-000519

(51) Int. Cl. G09G 3/36

(52) U.S. Cl. 345/100

(57) ABSTRACT

In a data line driver for driving N (N=2, 3, . . . ) data lines of a display apparatus including cascaded M (M=2, 3, . . . ) data line driver sections, each of the data line driver sections is constructed by a digital signal receiving and holding section adapted to receive and hold N/M digital video signals in synchronization with a first clock signal, a digital/analog converter adapted to perform a digital/analog conversion upon the N/M digital video signals in synchronization with a second clock signal whose rate is smaller than that of said first clock signal, to generate N/M analog video signals, and an analog video signal receiving and holding section adapted to receive and hold the N/M analog video signals.

### BACKGROUND OF THE INVENTION

1. Field of the Invention

The present invention relates to a data line driver of a plane type display apparatus such as a liquid crystal display (LCD) apparatus or an organic electroluminescence (EL) display apparatus.

2. Description of the Related Art

In a plane type display apparatus including a panel having data lines (or signal lines), scan lines (or gate lines) and cells each located at one intersection between the data lines and the scan lines, a data line driver for driving the data lines and a scan line driver for driving the scan lines are provided.

Generally, the data line driver has a plurality of decoders or digital/analog (D/A) converters each for one video signal or one data line. In this case, the more the gradation voltages, the more the number of connections of digital video signals. For example, if 262144 (=64=64=64) gradation voltages are required, the number of connections of three digital color video signals is 6, so that 2⁶ connections are required in each D/A converter of a non-dot-inversion type LCD apparatus and 2⁶=2 connections are required in each D/A converter of a dot-inversion type LCD apparatus. Therefore, in order to decrease the size of the data line driver, the decrease of the number of D/A converters is indispensable.

A prior art data line driver is constructed by a plurality of n-bit shift registers having N/M stages where n is the number of bits of one video signal, N is the number of data lines and M is the number of the shift registers, and a plurality of D/A converters each connected to one of the shift registers (see: JP-A-3-121415). As a result, the number of D/A converters can be decreased to decrease the size of the data line driver. This will be explained later in detail.

However, if the above-described prior art D/A converter is applied to a data line driver including cascaded data line driver sections, the sampling period corresponding to the D/A conversion period is not so long.

### SUMMARY OF THE INVENTION

It is an object of the present invention to provide a data line driver including cascaded data line driver sections having a long sampling period corresponding to a D/A conversion period to improve display quality.

According to the present invention, in a data line driver for driving N (N=2, 3, . . . ) data lines of a display apparatus including cascaded M (M=2, 3, . . . ) data line driver sections, each of the data line driver sections is constructed by a digital signal receiving and holding section adapted to receive and hold N/M digital video signals in synchronization with a first clock signal, a digital/analog converter adapted to perform a digital/analog conversion upon the N/M digital video signals in synchronization with a second clock signal whose rate is smaller than that of said first clock signal, to generate N/M analog video signals, and an analog video signal receiving and holding section adapted to receive and hold the N/M analog video signals.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a first prior art LCD apparatus;

FIG. 2 is a detailed block circuit diagram of the data line driver of FIG. 1;

FIG. 3 is a timing diagram for explaining the operation of the data line driver of FIG. 2;

FIG. 4 is a detailed partial timing diagram of the timing diagram of FIG. 3;

FIG. 5 is a block circuit diagram illustrating a second prior art LCD apparatus;

FIG. 6 is a timing diagram for explaining the operation of the data line driver of FIG. 5;

FIG. 7 is a block circuit diagram illustrating one data line driver section of a first embodiment of the data line driver according to the present invention;

FIG. 8 is a detailed block circuit of the data line driver section of FIG. 7;

FIG. 9 is a timing diagram for explaining the operation of the data line driver of FIG. 7;

FIG. 10 is a timing diagram for explaining the effect of the data line driver of FIG. 9;

FIG. 11 is a block circuit diagram illustrating one data line driver section of a second embodiment of the data line driver according to the present invention;

FIG. 12 is a detailed block circuit of the data line driver section of FIG. 11;

FIG. 13 is a timing diagram for explaining the operation of the data line driver of FIG. 11;

FIG. 14 is a timing diagram for explaining the effect of the data line driver of FIG. 13;

FIG. 15 is a block circuit diagram illustrating one data line driver section of a third embodiment of the data line driver according to the present invention;

FIG. 16 is a detailed block circuit of the data line driver section of FIG. 15;

FIG. 17 is a timing diagram for explaining the operation of the data line driver of FIG. 15; and

FIG. 18 is a timing diagram for explaining the effect of the data line driver of FIG. 17.

### DESCRIPTION OF THE PREFERRED EMBODIMENTS

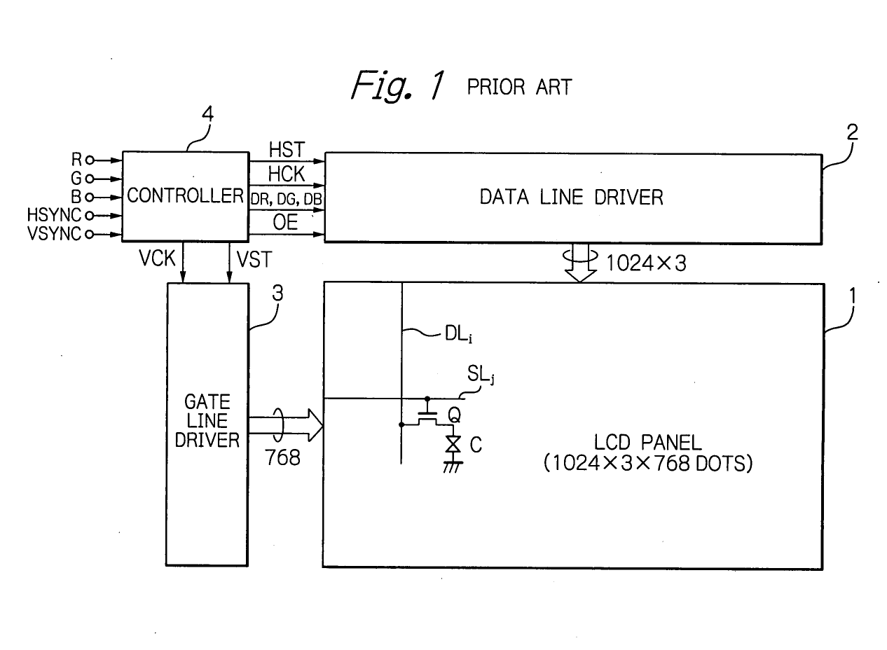

Before the description of the preferred embodiments, a prior art LCD apparatus will be explained with reference to FIGS. 1, 2, 3, 4, 5 and 6.

In FIG. 1, which illustrates a first prior art LCD apparatus (FIGS. 1 to 3 of JP-3-121415), reference numeral 1 designates an LCD panel having 1024×1028 pixels each formed by three color dots, i.e., R (red), G (green) and B (blue). Therefore, the LCD panel 1 includes 2359296 dots located at 3072 (=1024×3) data lines (or signal lines) DLᵢ and 768 scan lines (or gate lines) SLⱼ. One dot is formed by one thin film transistor Q and one liquid crystal cell C. For example, if one dot is represented by 64 gradation voltages, one pixel is represented by 262144 (=64×64×64) colors. This LCD panel is called an extended graphics array (XGA). Note that the LCD panel 1 includes 3932166 (=1280×3×1024) dots in a super extended graphics array (SXGA) and 5760000 (=1600×3×1200) dots in an ultra extended graphics array (UXGA).

A controller 4 receives color signals R, G and B, a horizontal synchronization signal HSYNC and a vertical synchronization signal VSYNC from the exterior to generate a horizontal start signal HST, a horizontal clock signal HCK, video data signals DR, DG and DB, an output enable signal OE for the data line driver 2, and a vertical start signal VST and a vertical clock signal VCK for the gate line driver 3.

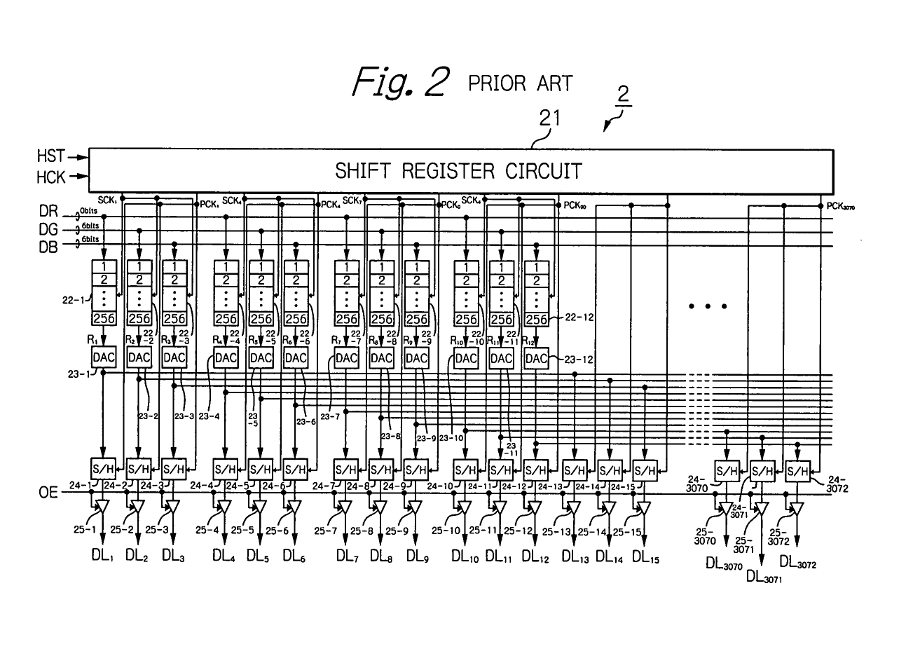

In FIG. 2, which is a detailed block circuit diagram of the data line driver 2 of FIG. 1, the data line driver 2 is constructed by a shift register circuit 21 for receiving the horizontal start signal HST and the horizontal clock signal HCK to generate shift clock signals SCK₁, SCK₄, SCK₇ and SCK₁₀ and sampling signals PCK₁, PCK₄, PCK₇, PCK₁₀, . . . , PCK₃₀₇₀. The shift clock signals SCK₁, SCK₄, SCK₇ and SCK₁₀ shift shift registers 22-1, 22-2, 22-3; 22-4, 22-5, 22-6; 22-7, 22-8, 22-9; and 22-10, 22-11, 22-12, which are connected to D/A converters 23-1, 23-2, 23-3; 23-4, 23-5, 23-6; 23-7, 23-8, 23-9; and 23-10, 23-11, 23-12. The sampling signals PCK₁, PCK₄, PCK₇, PCK₁₀, . . . , PCK₃₀₇₀ are supplied to sample/hold circuits 24-1, 24-2, 24-3; 24-4, 24-5, 24-6; 24-7, 24-8, 24-9; 24-10, 24-11, 24-12; . . . ; 24-3070, 24-3071, 24-3072. The output signals of the sample/hold circuits 24-1, 24-2, . . . , 24-3072 are outputted by output buffers 25-1, 25-2, . . . , 25-372 enabled by the output enable signal OE to the data lines DL₁, DL₂, . . . , DL₃₀₇₂.

In FIG. 2, the number of D/A converters, which is 12 (=4×3), for example, is remarkably smaller than that of the data lines, so that the data line driver 2 can be reduced in size.

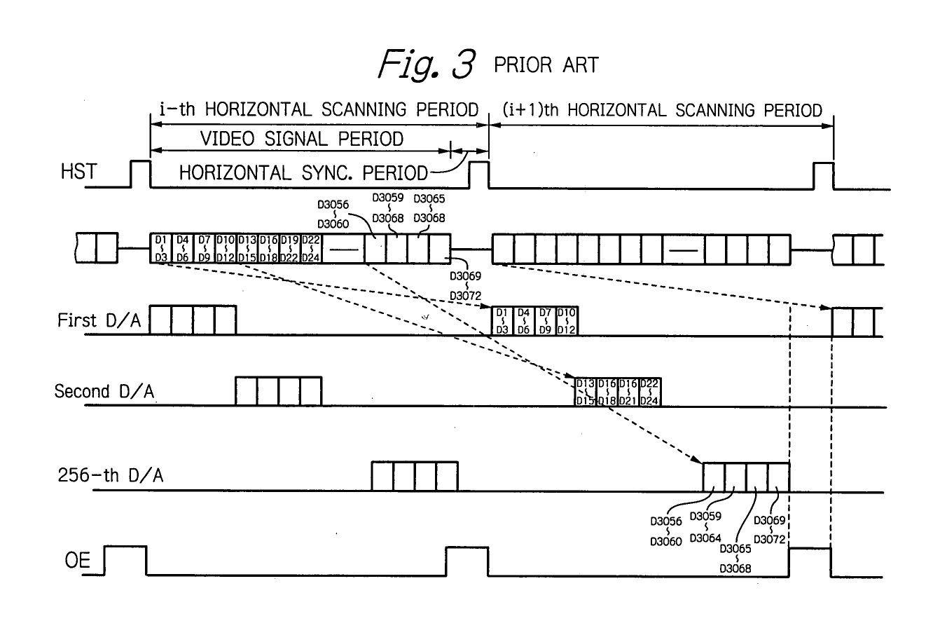

In FIG. 3, which is a timing diagram for explaining the operation of the data line driver 2 of FIG. 2, four pixels, i.e., twelve dots such as D1 to D3, D4 to D6, D7 to D9 and D10 to D12 are subjected to each A/D conversion, so that 256 (=1024/4) A/D conversions are carried out for each horizontal scanning period, to obtain 3072 analog video signals which are transmitted simultaneously by the output enable signal OE to the data lines DL₁, DL₂, . . . , DL₃₀₇₂. Since the digital video signals are supplied though the shift registers 22-1, 22-2, . . . , 22-12, the analog video signals are delayed by one horizontal scanning period as compared with the digital video signals.

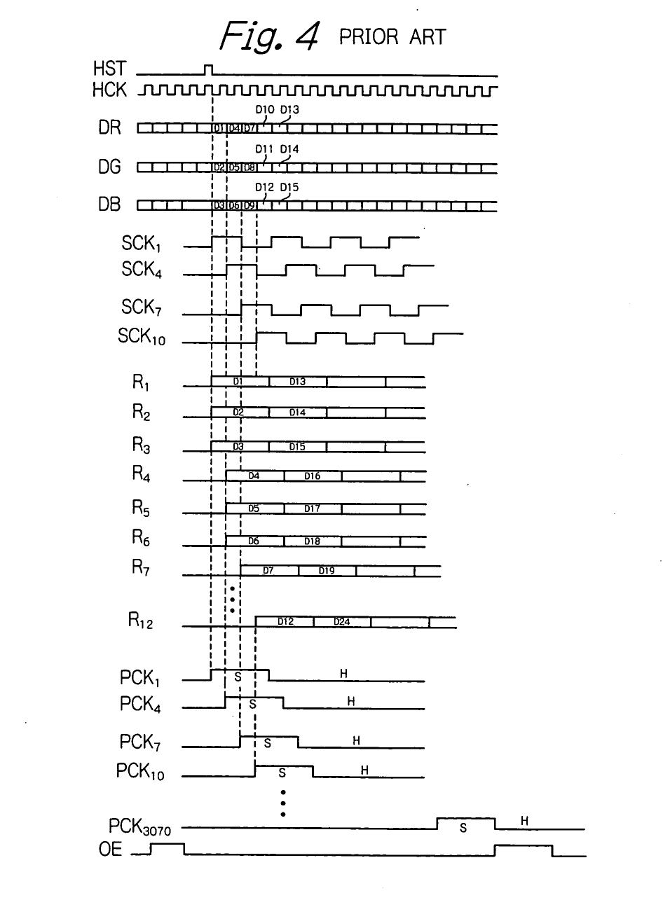

In FIG. 4, which is also a detailed partial timing diagram of the timing diagram of FIG. 3, the period of the shift clock signals SCK₁, SCK₂, SCK₃ and SCK₄ is four times that of the horizontal clock signal HCK and their phases are shifted by one period of the horizontal clock signal HCK. As a result, the shift registers 22-1, 22-2, . . . , 22-12 fetch every four pixel (twelve dots), and generate them from their outputs R₁, R₂, . . . , R₁₂ to the D/A converters 23-1, 23-2, 23-12. The analog signals of the D/A converters 23-1, 23-2, . . . , 23-12 are sampled by the sampling signals PCK₁, PCK₄, PCK₇, PCK₁₀, . . . , PCK₃₀₇₀ in the sample/hold circuits 24-1, 24-2, . . . , 24-3072. Finally, the analog signals of the sample/hold circuits 24-1, 24-2, 24-3072 are simultaneously output by the output enable signal OE.

In FIGS. 1 to 4, since the sampling period defined by the sampling signals PCK₁, PCK₄, PCK₇, PCK₁₀, . . . , PCK₃₀₇₀ can be four times the period of the horizontal clock signal HCK, the offset voltage of the sample/hold circuits 24-1, 24-2, . . . , 24-3072 can be decreased, which would not degrade the display quality.

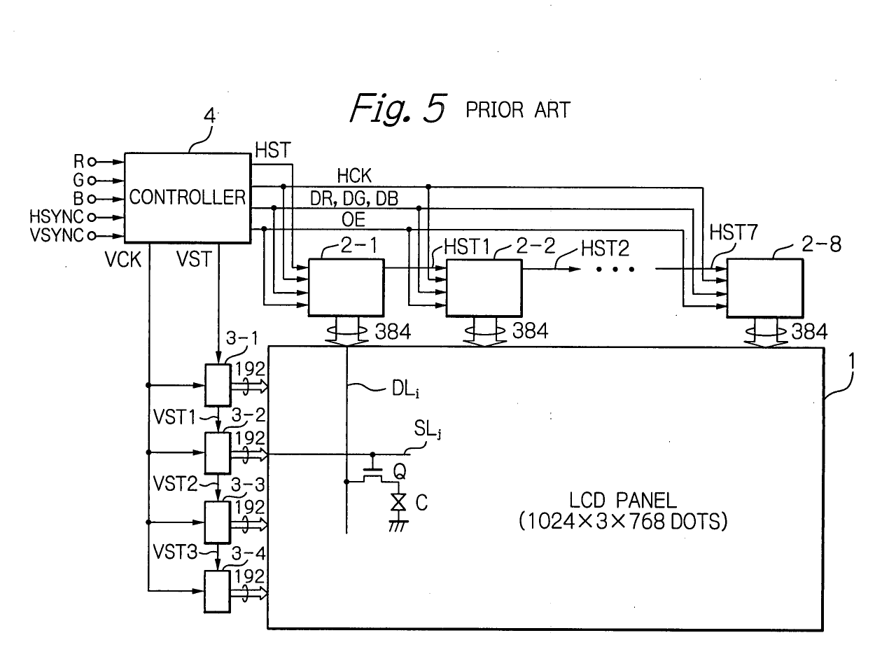

In FIG. 5, which illustrates a second prior art LCD apparatus, the data line driver 2 of FIG. 1 is replaced by cascaded data line driver sections 2-1, 2-2, . . . , 2-8 each driving 384 data lines, and the scan line driver 3 of FIG. 1 is replaced by cascaded scan line driver sections 3-1, 3-2, 3-3 and 3-4 each driving 192 scan lines.

In FIG. 5, the data line driver sections 2-1, 2-2, . . . , 2-8 are arranged by a cascade connection method to pass the horizontal start signal HST therethrough in synchronization with the horizontal clock signal HCK. In this case, if a horizontal start signal output from the data line driver section 2-1 is denoted by HST1, the horizontal start signal HST1 is supplied to the data line driver section 2-2. Also, if a horizontal start signal output from the data line driver section 2-2 is denoted by HST2, the horizontal start signal HST2 is supplied to the data line driver section 2-3. Further, if a horizontal start signal output from the data line driver section 2-7 is denoted by HST7, the horizontal start signal HST7 is supplied to the data line driver section 2-8.

Similarly, in FIG. 5, the scan line driver sections 3-1, 3-2, 3-3 and 3-4 are arranged by a cascade connection method to pass the vertical start signal VST therethrough in synchronization with the vertical clock signal VCK. In this case, if a vertical start signal output from the scan line driver section 3-1 is denoted by VST1, the vertical start signal VST1 is supplied to the scan line driver section 3-2. Also, if a vertical start signal output from the data line driver section 3-2 is denoted by VST2, the vertical start signal VST2 is supplied to the scan line driver section 3-3. Further, if a vertical start signal output from the scan line driver section 3-3 is denoted by VST3, the vertical start signal VST3 is supplied to the scan line driver section 3-4.

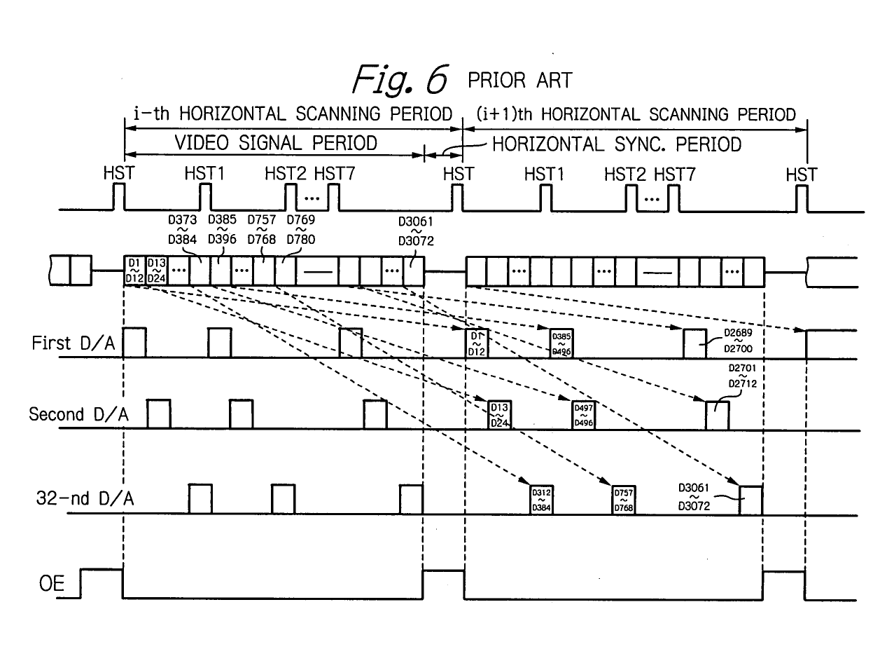

If the configuration of the data line driver of FIG. 2 is applied to each of the data line driver sections 2-1, 2-2, . . . , 2-8 of FIG. 5, the operation of the data line driver sections 2-1, 2-2, . . . , 2-8 is shown in FIG. 6. That is, as illustrated in FIG. 6, D/A conversion performed upon the digital video data D1˜D384 is carried out within T/8 where T is a video signal period. Also, D/A conversion performed upon the digital video data D385˜D768 is carried out within T/8. Further, D/A conversion performed upon the digital video data D2689˜D3072 is carried out within T/8. Therefore, as the number of cascaded data line driver sections is increased, the sampling period corresponding to the D/A conversion period needs to be decreased, i.e., the sampling period corresponding to the D/A conversion period needs to be three times or smaller than the period of the horizontal clock signal HCK, so that the sampling periods are not so long.

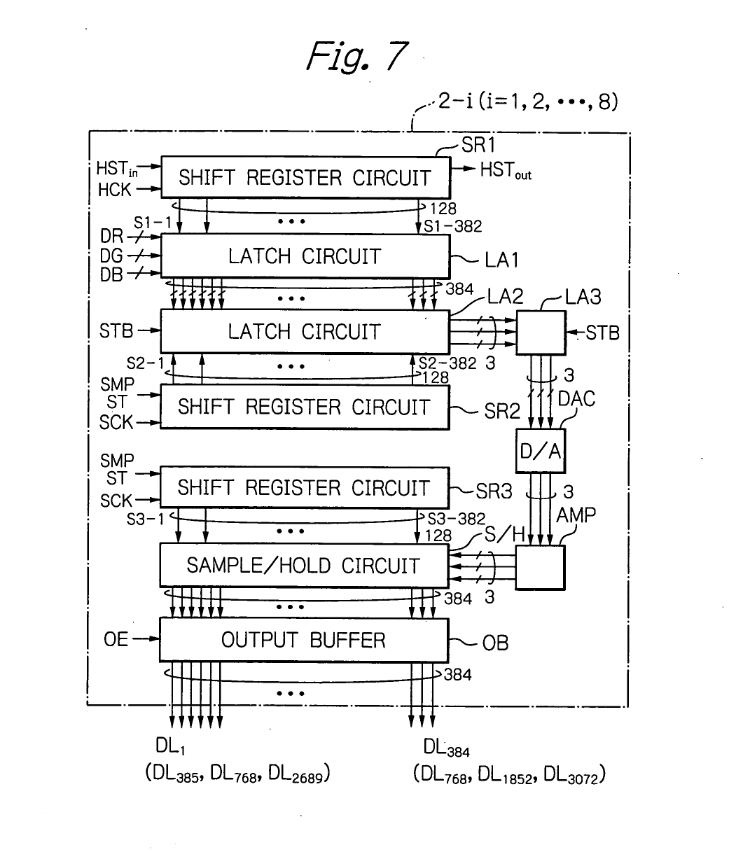

In FIG. 7, which is a block circuit diagram illustrating one data line driver section of a first embodiment of the data line driver according to the present invention, this data line driver section is applied to one of the data sections 2-i of FIG. 5.

In FIG. 7, the data line driver section 2-i is constructed by a shift register circuit (transfer section) SR1, a latch circuit (digital signal storing section) LA1, a shift register circuit (transfer section) SR2, a latch circuit (digital signal storing section) LA2, a latch circuit (digital signal storing section) LA3, a D/A converter circuit DAC, an amplifier circuit AMP, a shift register circuit (transfer section) SR3, a sample/hold circuit (analog signal storing section) S/H, and an output buffer OB.

The shift register circuit SR1, the latch circuit LA1, the shift register circuit SR2, the latch circuit LA2 and the latch circuit LA3 form a digital signal receiving/holding section, and the shift register circuit SR3, the sample/hold circuit S/H and the output buffer OB form an analog signal receiving/holding section.

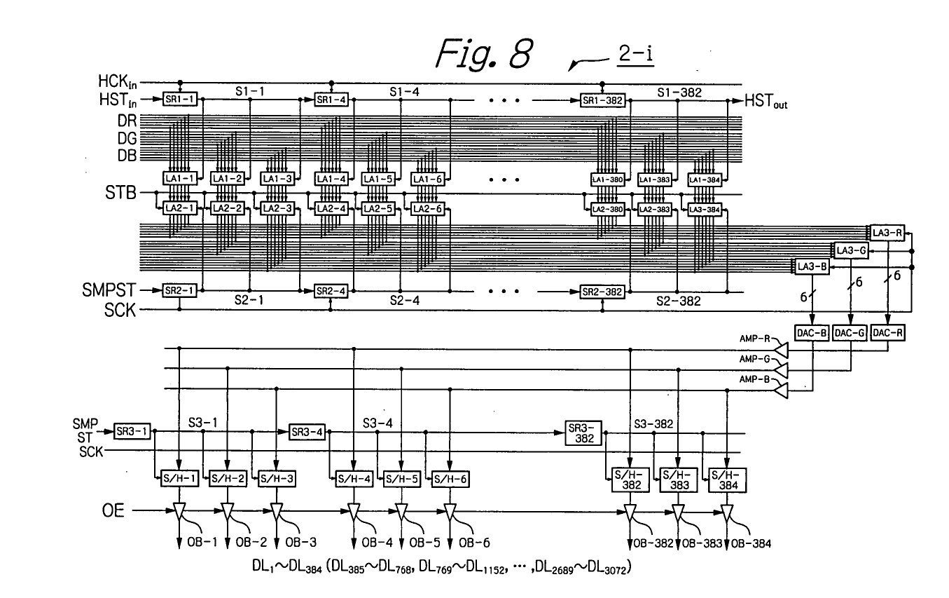

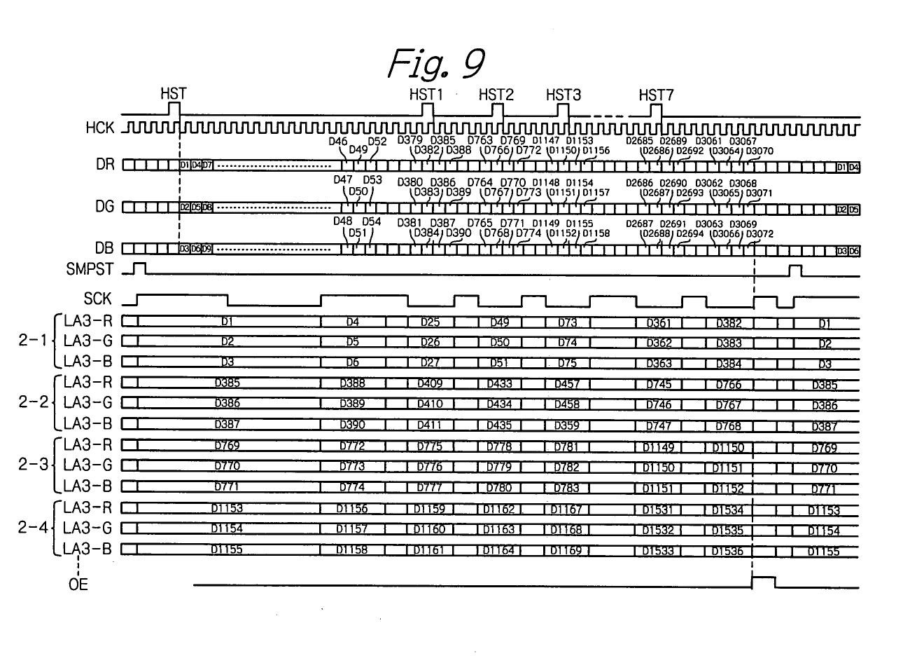

FIG. 8 is a detailed circuit diagram of the data line driver section 2-i of FIG. 7, and FIG. 9 is a timing diagram for explaining the operation of the data line driver of FIG. 7.

Each element of the data line driver section 2-i of FIG. 7 is explained in detail next with reference to FIGS. 8 and 9.

The shift register circuit SR1 shifts a horizontal start signal HSTᵢₙ from a controller such as the controller 4 of FIG. 5 in synchronization with a horizontal clock signal HCK from the controller, to generate latch signals S1-1, S1-2, . . . , S1-382 and also, a horizontal start signal HSTₒᵤₜ for the next stage data line driver if any. That is, as illustrated in FIG. 8, the shift register circuit SR1 is constructed by 128 shift registers SR1-1, SR1-4, . . . , SR1-382.

The latch circuit LA1 latches video signals (18 bits) formed by red data (DR) (6 bits), green data (DG) (6 bits) and blue data (DB) (6 bits) from the controller in synchronization with the latch signals S1-1, S1-4, . . . , S1-382, respectively. That is, as illustrated in FIG. 8, the latch circuit LA1 is constructed by 384 latches LA1-1, LA1-2, . . . , LA1-384.

The latch circuit LA2 latches the digital video signals DR, DG and DB latched by the latch circuit LA1 in synchronization with a strobe signal STB from the controller.

On the other hand, the shift register circuit SR2 shifts a start signal SMPST from the controller in synchronization with a clock signal SCK whose rate is eight times smaller than that of the horizontal clock signal HCK, to generate latch signals S2-1, S2-4, S2-382. The clock signal SCK is also generated from the controller. That is, as illustrated in FIG. 8, the shift register circuit SR2 is constructed by 128 shift registers SR2-1, SR2-4, . . . , SR2-382.

As a result, the three data DR, DG and DB (6 bits×3) are read in synchronization with the latch signals S2-1, S2-4, . . . , S2-382, and are latched in the latch circuit LA3 in synchronization with the clock signal SCK. That is, as illustrated in FIG. 8, the latch circuit LA3 is constructed by three latches LA3-R, LA3-G and LA3-B.

The latch circuits LA1, LA2 and LA3 perform a pipeline processing upon data of two scanning lines during one horizontal scanning period.

As illustrated in FIG. 9, in the data line driver section 2-1, data D1 to D384 (6 bits) are sequentially latched in the latch circuit LA3 during one horizontal scanning period (video signal period). Similarly, in the data line driver section 2-2, data D385 to D768 (6 bits) are sequentially latched in the latch circuit LA3 during the same horizontal scanning period (video signal period).

Again in FIG. 7, the three data DR, DG and DB (6 bits×3) latched in the latch circuit LA3 are subject to D/A conversions in the D/A converter DAC to generate three analog video signals. That is, as illustrated in FIG. 8, the D/A converter DAC is constructed by D/A converter elements DAC-R, DAC-G and DAC-B.

The three analog video signals are supplied to the amplifier circuit AMP to substantially increase the speed of the D/A converter DAC. That is, as illustrated in FIG. 8, the amplifier circuit AMP is constructed by three amplifiers AMP-R, AMP-G and AMP-B.

Additionally, the shift register circuit SR3 shifts the start signal SMPST from the controller in synchronization with the clock signal SCK. That is, as illustrated in FIG. 8, the shift register circuit SR3 is constructed by shift registers SR3-1, SR3-4, . . . , SR3-382.

The three analog video signals are sequentially sampled in the sample/hold circuit S/H in synchronization with the latch signals S3-1, S3-4, . . . , S3-382. That is, as illustrated in FIG. 8, the sample/hold circuit S/H is constructed by 384 sample/hold elements S/H-1, S/H-2, . . . , S/H-384.

The analog video data in the sample/hold circuit S/H are supplied to the output buffer OB which supplies the analog data to the data lines DL₁, DL₂, . . . , DL₃₈₄. That is, as illustrated in FIG. 8, the sample/hold circuit S/H is constructed by 384 sample/hold sections S/H-1, S/H-2, . . . , S/H-384.

The analog video data sampled in the sample/hold circuit S/H are output by the output buffer OB in synchronization with the output enable signal OE to the data lines DL₁, DL₂, . . . , DL₃₈₄ (DL₃₈₅, DL₃₈₆, . . . , DL₇₆₈; DL₇₆₉, DL₇₇₀, . . . , DL₁₅₂; . . . ; DL₂₆₈₉, DL₂₆₉₀, . . . , DL₃₀₇₂). That is, as illustrated in FIG. 8, the output buffer OB is constructed by 384 buffers OB-1, OB-2, . . . , OB-384.

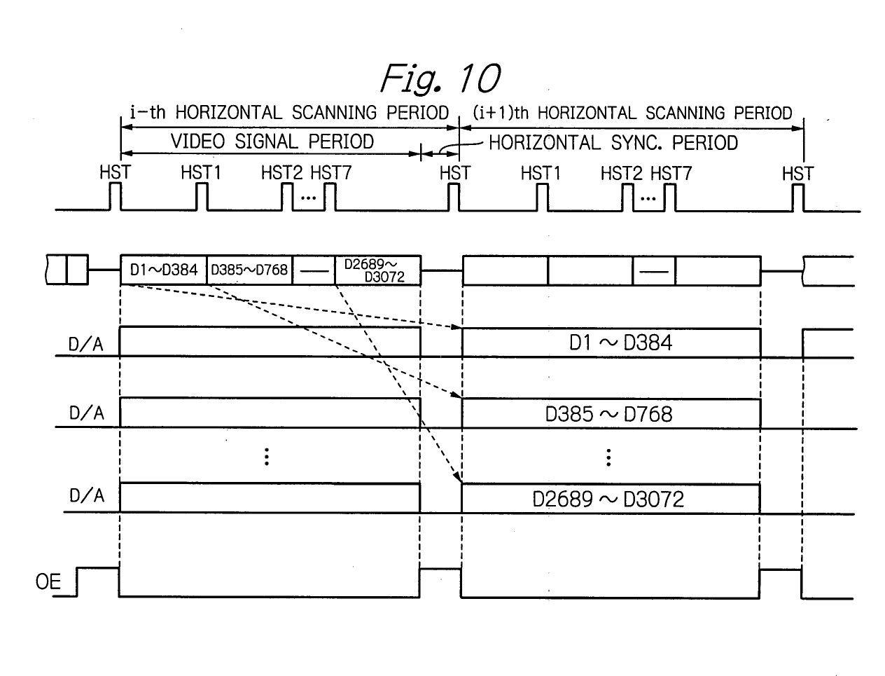

If the configuration of the data line driver section of FIG. 7 is applied to each of the data line driver sections 2-1, 2-2, . . . , 2-8 of FIG. 5, the operation of the data line driver sections 2-1, 2-2, . . . , 2-8 are shown in FIG. 10, where data of two scanning lines is subjected to a pipeline processing. That is, as illustrated in FIG. 10, D/A conversion performed upon the digital video data D1˜D384 is carried out within T. Also, D/A conversion performed upon the digital video data D385˜D768 is carried out within T. Further, D/A conversion performed upon the digital video data D2689˜D3072 is carried out within T. Therefore, even when the number of cascaded data line driver sections is increased, the sampling period corresponding to the D/A conversion period need not be decreased, i.e., the sampling period corresponding to the D/A conversion period can be four times or larger than the period of the horizontal clock signal HCK, so that the sampling period can be very long.

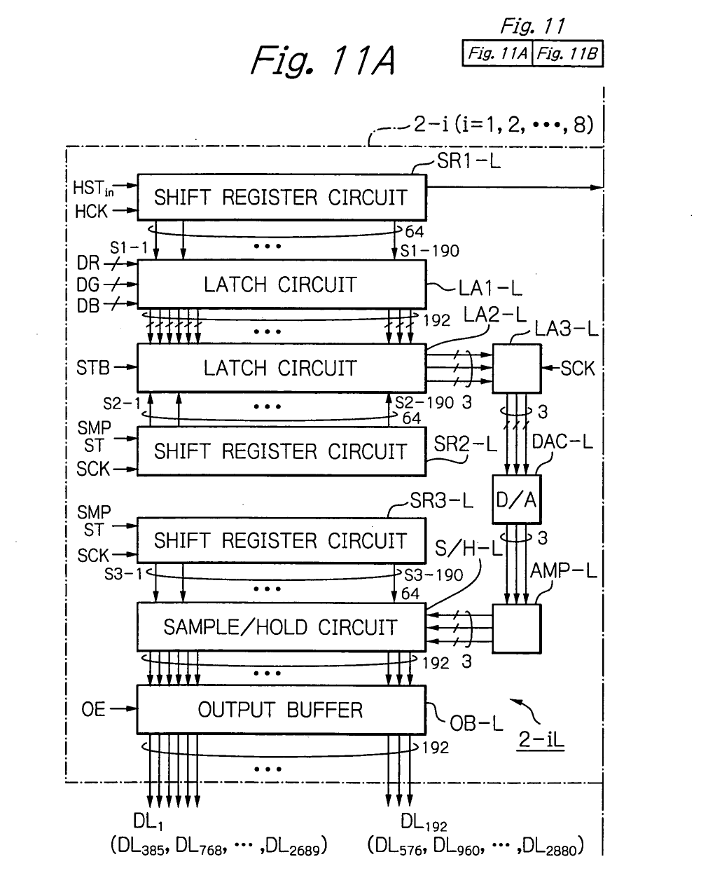

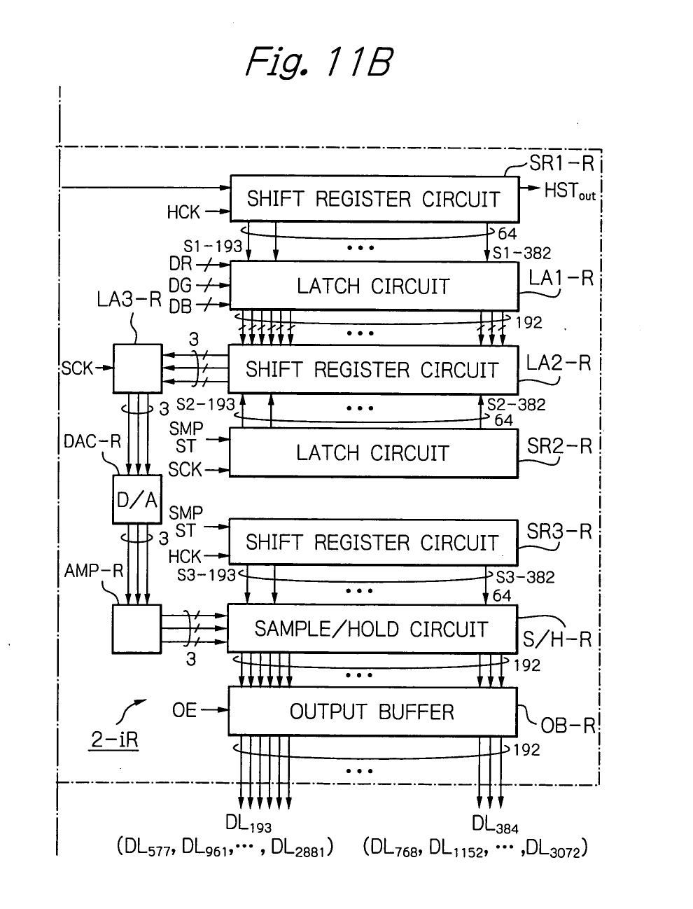

In FIG. 11, which is a block circuit diagram illustrating one data line driver section of a second embodiment of the data line driver according to the present invention, this data line driver section is also applied to one of the data line driver sections 2-i of FIG. 5.

In FIG. 11, the data line driver section 2-i is divided into two cascaded sub data line driver sections 2-iL and 2-iR which have the same configuration. That is, the sub data driver section 2-iL is constructed by a shift register circuit (transfer section) SR1-L, a latch circuit (digital signal storing section) LA1-L, a shift register circuit (transfer section) SR2-L, a latch circuit (digital signal storing section) LA2-L, a latch circuit (digital signal storing section) LA3-L, a D/A converter circuit DAC-L, an amplifier circuit AMP-L, a shift register circuit (transfer section) SR3-L, a sample/hold circuit S/H-L, and an output buffer OB-L. Similarly, the sub data driver section 2-iR is constructed by a shift register circuit (transfer section) SR1-R, a latch circuit (digital signal storing section) LA1-R, a shift register circuit (transfer section) SR2-R, a latch circuit (digital signal storing section) LA2-R, a latch circuit (digital signal storing section) LA3-R, a D/A converter circuit DAC-R, an amplifier circuit AMP-R, a shift register circuit (transfer section) SR3-R, a sample/hold circuit S/H-R, and an output buffer OB-R.

The shift register circuit SR1-L (SR1-R), the latch circuit LA1-L (LA1-R), the shift register circuit SR2-L (SR2-R), the latch circuit LA2-L (LA2-R) and the latch circuit LA3-L (LA3-R) form a digital signal receiving/holding section, and the shift register circuit SR3-L (SR3-R), the sample/hold circuit S/H-L (S/H-R) and the output buffer OB-L (OB-R) form an analog signal receiving/holding section.

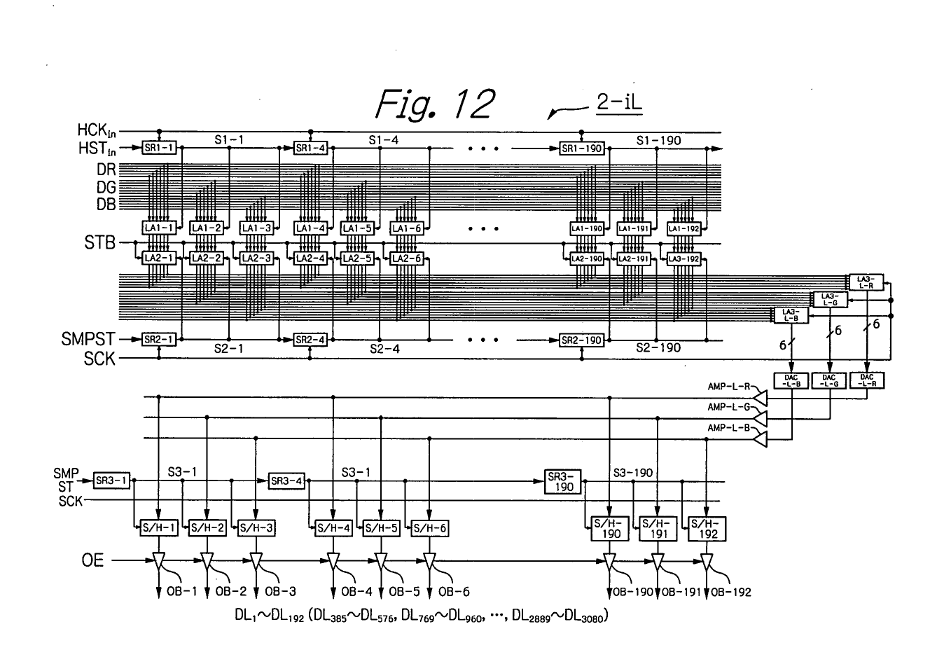

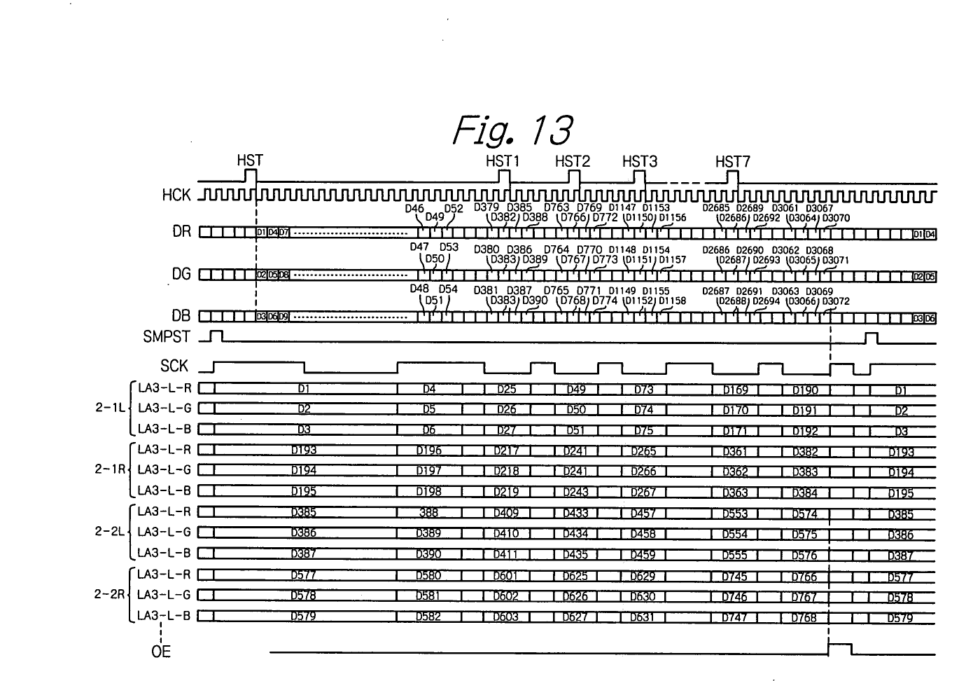

FIG. 12 is a detailed circuit diagram of the data line driver section 2-i of FIG. 11, and FIG. 13 is a timing diagram for explaining the operation of the data line driver section 2-i of FIG. 11 and the other data line driver sections.

Each element of the data line driver section 2-i of FIG. 11 is explained in detail next with reference to FIGS. 12 and 13.

The shift register circuit SR1-L shifts a horizontal start signal HSTᵢₙ from a controller such as the controller 4 of FIG. 5 in synchronization with a horizontal clock signal HCK from the controller, to generate latch signals S1-1, S1-4, . . . , S1-190. That is, as illustrated in FIG. 12, the shift register circuit SR1-L is constructed by 128 shift registers SR1-1, SR1-4, . . . , SR1-190. Similarly, the shift register circuit SR1-R generates latch signals S1-193, S1-196, . . . , S1-382 (not shown) and also, a horizontal start signal HSTₒᵤₜ for the next stage data line driver section if any.

The latch circuit LA1-L latches video signals (18 bits) formed by red data (DR) (6 bits), green data (DG) (6 bits) and blue data (DB) (6 bits) from the controller in synchronization with the latch signals S1-1, S1-4, . . . , S1-190. That is, as illustrated in FIG. 12, the latch circuit LA1-L is constructed by 192 latches LA1-1, LA1-2, . . . , LA1-192. Similarly, the LA1-R is constructed by 192 latches LA1-193, LA1-194, LA1-384 (not shown).

The latch circuit LA2-L latches the digital video signals DR, DG and DB latched by the latch circuit LA1-L in synchronization with a strobe signal STB from the controller. Similarly, the latch circuit LA2-R latches the digital video signals DR, DG and DB latched by the latch circuit LA1-R in synchronization with the strobe signal STB from the controller.

On the other hand, the shift register circuit SR2-L shifts a start signal SMPST from the controller in synchronization with a clock signal SCK whose rate is sixteen times smaller than that of the horizontal clock signal HCK, to generate latch signals S2-1, S2-4, S2-190. The clock signal SCK is also generated from the controller. That is, as illustrated in FIG. 12, the shift register circuit SR2-L is constructed by 64 shift registers SR2-1, SR2-4, . . . , SR2-190. Similarly, the shift register circuit SR2-R is constructed by 64 shift registers SR2-193, SR2-196, . . . , SR2-382 (not shown).

As a result, the three data DR, DG and DB (6 bits×3) are read in synchronization with the latch signals S2-1, S2-4, . . . , S2-382, and are latched in the latch circuits LA3-L and LA3-R in synchronization with the clock signal SCK. That is, as illustrated in FIG. 12, the latch circuit LA3-L is constructed by three latches LA3-L-R, LA3-L-G and LA3-L-B. Similarly, the latch circuit LA3-R is constructed by three latches LA3-R-R, LA3-R-G and LA3-R-B (not shown).

The latch circuits LA1-L, LA1-R, LA2-L, LA2-R, LA3-L and LA3-R perform a pipeline processing upon data of two scanning lines.

As illustrated in FIG. 13, in the sub data line driver section 2-1L, data D1 to D192 (6 bits) are sequentially latched in the latch circuit LA3-L during one horizontal scanning period (video signal period). Also, in the sub data line driver section 2-1R, data D193 to D267 (6 bits) are sequentially latched in the latch circuit LA3-R during one horizontal scanning period (video signal period). Similarly, in the sub data line driver section 2-2L, data D385 to D576 (6 bits) are sequentially latched in the latch circuit LA3-L during the same horizontal scanning period (video signal period). Also, in the sub data line driver section 2-2R, data D577 to D747 (6 bits) are sequentially latched in the latch circuit LA3-R during the same horizontal scanning period (video signal period).

Again in FIG. 11, the three data DR, DG and DB (6 bits×3) latched in the latch circuits LA3-L and LA3-R are subject to D/A conversions in the D/A converters DAC-L and DAC-R to generate three analog video signals. That is, as illustrated in FIG. 12, the D/A converter DAC-L is constructed by D/A converter elements DAC-L-R, DAC-L-G and DAC-L-B. Similarly, the D/A converter DAC-R is constructed by D/A converter elements DAC-R-R, DAC-R-G and DAC-R-B (not shown).

The three analog video signals are supplied to the amplifier circuits AMP-L and AMP-R to substantially increase the rate of the amplifier circuits AMP-L and AMP-R. That is, as illustrated in FIG. 12, the amplifier circuit AMP-L is constructed by three amplifiers AMP-L-R, AMP-L-G and AMP-L-B. Similarly, the amplifier circuit AMP-R is constructed by three amplifiers AMP-R-R, AMP-R-G and AMP-R-B (not shown).

Additionally, the shift register circuits SR3-L and SR3-R shift the start signal SMPST from the controller in synchronization with the clock signal SCK. That is, as illustrated in FIG. 12, the shift register circuit SR3-L is constructed by shift registers SR3-1, SR3-4, . . . , SR3-190. Similarly, the shift register circuit SR3-R is constructed by shift registers SR3-193, SR3-196, . . . , SR3-382 (not shown).

The three analog video signals are sequentially sampled in the sample/hold circuits S/H-L and S/H-R in synchronization with the latch signals S3-1, S3-4, . . . , S3-382. That is, as illustrated in FIG. 12, the sample/hold circuit S/H-L is constructed by 192 sample/hold elements S/H-1, S/H-2, . . . , S/H-192. Similarly, the sample/hold circuit S/H-R is constructed by 192 sample/hold elements S/H-193, S/H-194, . . . , S/H-384 (not shown).

The analog video data in the sample/hold circuits S/H-L and S/H-R are supplied to the output buffers OB-L and OB-R which supplies the analog data to the data lines DL₁, DL₂, . . . , DL₃₈₄. That is, as illustrated in FIG. 12, the sample/hold circuit S/H-L is constructed by 192 sample/hold sections S/H-1, S/H-2, . . . , S/H-192. Similarly, the sample/hold circuit S/H-R is constructed by 192 sample/hold sections S/H-193, S/H-194, . . . , S/H-384 (not shown).

The analog video data sampled in the sample/hold circuit S/H-L and S/H-R are outputted by the output buffers OB-L and OB-R in synchronization with the output enable signal OE to the data lines DL₁, DL₂, . . . , DL₃₈₄ (DL₃₈₅, DL₃₈₆, . . . , DL₇₆₈; DL₇₆₉, DL₇₇₀, . . . , DL₁₁₅₂; . . . ; DL₂₆₈₉, DL₂₆₉₀, . . . , DL₃₀₇₂). That is, as illustrated in FIG. 12, the output buffer OB-L is constructed by 192 buffers OB-1, OB-2, . . . , OB-192. Similarly, the output buffer OB-R is constructed by 192 buffers OB-193, OB-194, . . . , OB-384 (not shown).

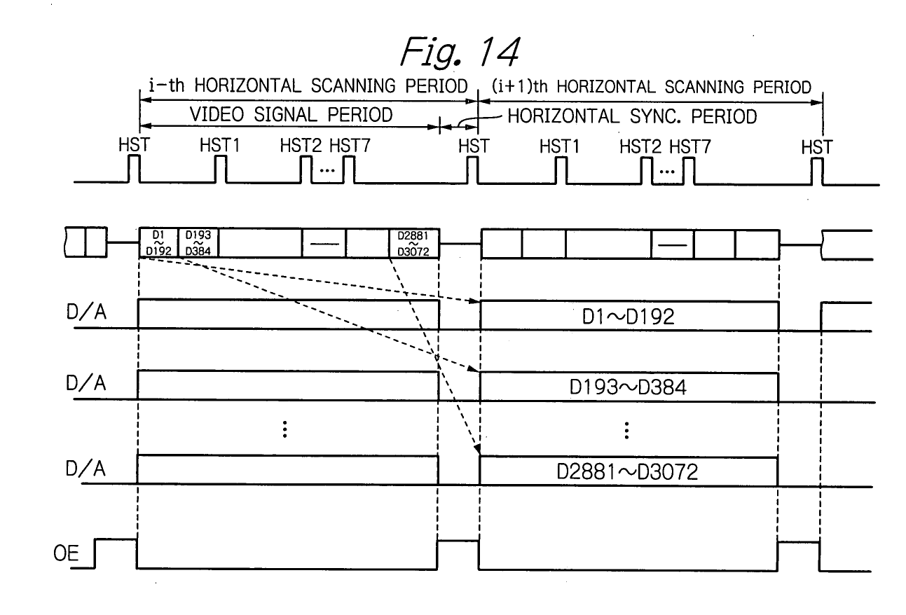

If the configuration of the data line driver section of FIG. 11 is applied to each of the data line driver sections 2-1, 2-2, . . . , 2-8 of FIG. 5, the operation of the data line driver sections 2-1, 2-2, . . . , 2-8 is shown in FIG. 14, where data of two scanning lines is subjected to a pipeline processing. That is, as illustrated in FIG. 14, D/A conversion performed upon the digital video data D1˜D192 is carried out within T. Also, D/A conversion performed upon the digital video data D193˜D384 is carried out within T. Further, D/A conversion performed upon the digital video data D2881˜D3072 is carried out within T. Therefore, even when the number of cascaded data line driver sections is increased, the sampling period corresponding to the D/A conversion period need not be decreased, i.e., the sampling period corresponding to the D/A conversion period can be four times or larger than the period of the horizontal clock signal HCK, so that the sampling period can be even longer.

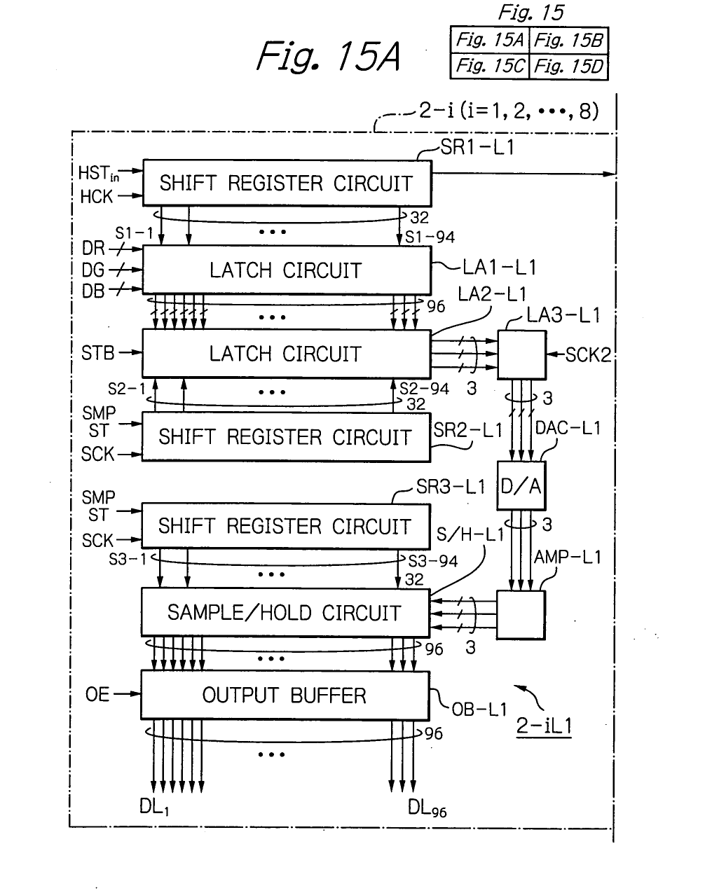

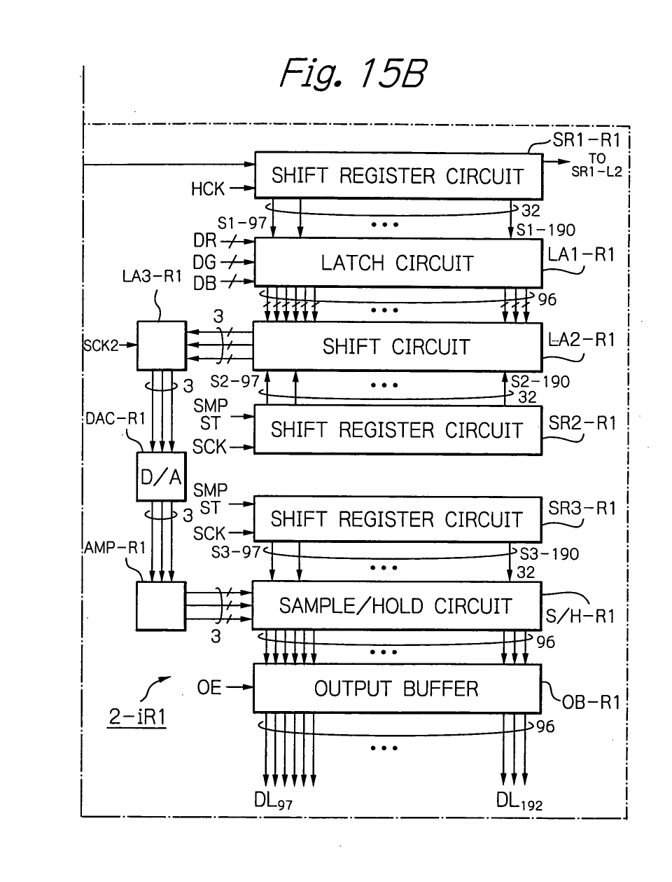

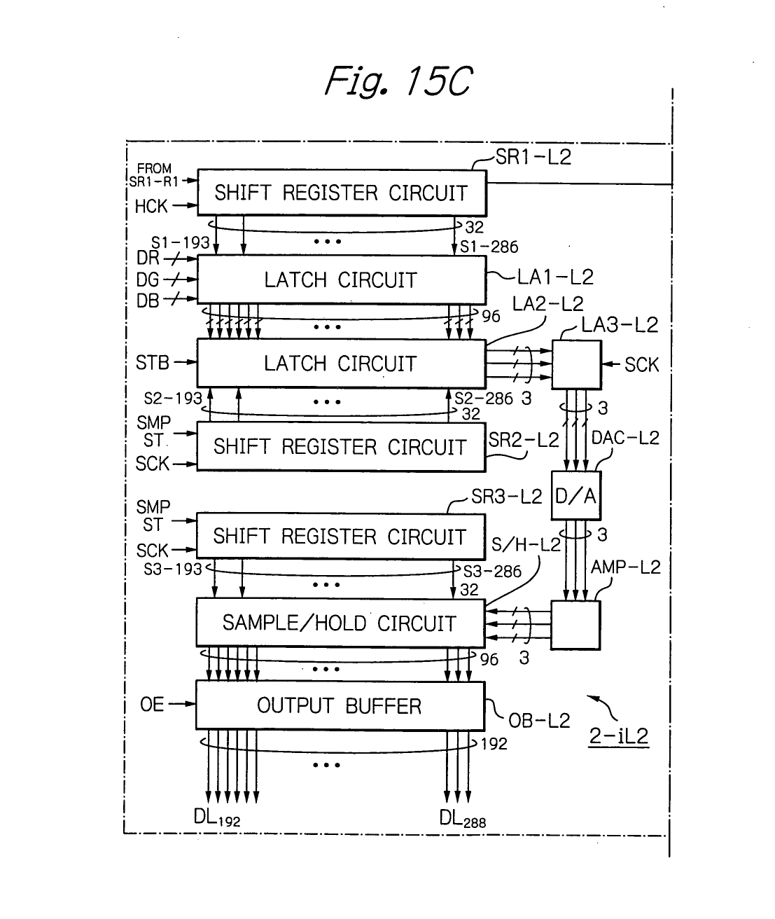

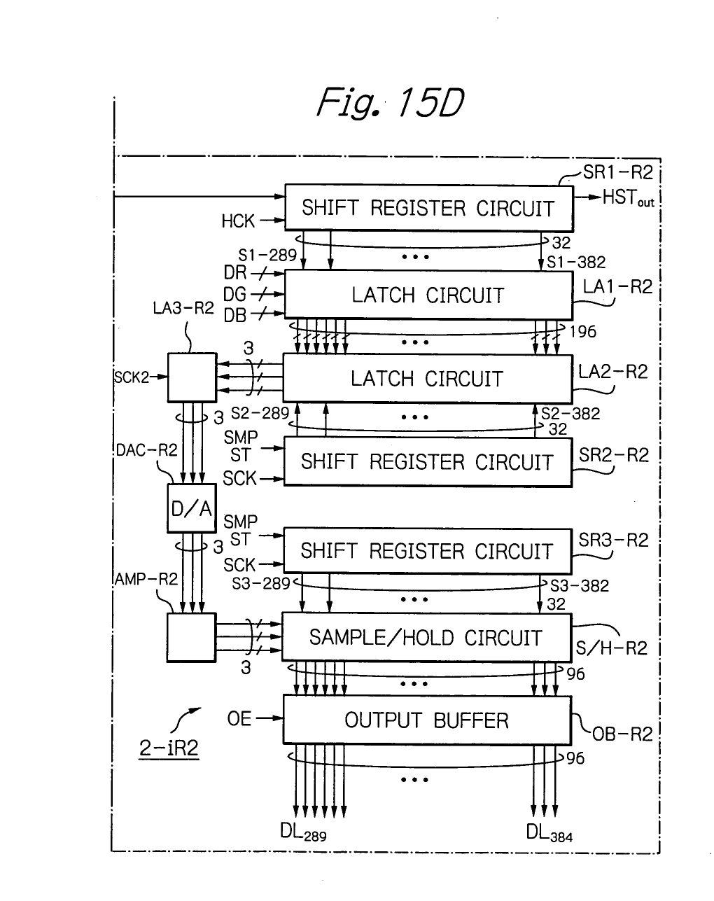

In FIG. 15, which is a block circuit diagram illustrating one data line driver section of a third embodiment of the data line driver according to the present invention, this data line driver sections is also applied to one of the data line driver sections 2-i of FIG. 5.

In FIG. 15, the data line driver section 2-i is divided into four cascaded data line driver sections 2-iL, 2-iR1, 2-iL2 and 2-iR2 which have the same configuration. That is, the sub data driver section 2-iL1 is constructed by a shift register circuit (transfer section) SR1-L1, a latch circuit (digital signal storing section) LA1-L1, a shift register circuit (transfer section) SR2-L1, a latch circuit (digital signal storing section) LA2-L1, a latch circuit (digital signal storing section) LA3-L1, a D/A converter circuit DAC-L1, an amplifier circuit AMP-L1, a shift register circuit (transfer section) SR3-L1, a sample/hold circuit S/H-L1, and an output buffer OB-L1. Similarly, the sub data driver section 2-iR1 is constructed by a shift register circuit (transfer section) SR1-R1, a latch circuit (digital signal storing section) LA1-R1, a shift register circuit (transfer section) SR2-R1, a latch circuit (digital signal storing section) LA2-R1, a latch circuit (digital signal storing section) LA3-R1, a D/A converter circuit DAC-R1, an amplifier circuit AMP-R1, a shift register circuit (transfer section) SR3-R1, a sample/hold circuit S/H-R1, and an output buffer OB-R1. Also, the sub data driver section 2-iL2 is constructed by a shift register circuit (transfer section) SR1-L2, a latch circuit (digital signal storing section) LA1-L2, a shift register circuit (transfer section) SR2-L2, a latch circuit (digital signal storing section) LA2-L2, a latch circuit (digital signal storing section) LA3-L2, a D/A converter circuit DAC-L2, an amplifier circuit AMP-L2, a shift register circuit (transfer section) SR3-L2, a sample/hold circuit S/H-L2, and an output buffer OB-L2. Similarly, the sub data driver section 2-iR2 is constructed by a shift register circuit (transfer section) SR1-R2, a latch circuit (digital signal storing section) LA1-R2, a shift register circuit (transfer section) SR2-R2, a latch circuit (digital signal storing section) LA2-R2, a latch circuit (digital signal storing section) LA3-R2, a D/A converter circuit DAC-R2, an amplifier circuit AMP-R2, a shift register circuit (transfer section) SR3-R2, a sample/hold circuit S/H-R2, and an output buffer OB-R2.

The shift register circuit SR1-L1 (SR1-R1, SR1-L2, SR1-R2), the latch circuit LA1-L1 (LA1-R1, LA1-L2, LA1-R2), the shift register circuit SR2-L1 (SR2-R1, SR2-L2, SR2-R2), the latch circuit LA2-L1 (LA2-R1, LA2-L2, LA2-R2) and the latch circuit LA3-L1 (LA3-R1, LA3-L2, LA3-R2) form a digital signal receiving/holding section, and the shift register circuit SR3-L1 (SR3-R1, SR3-L2, SR3-R2), the sample/hold circuit S/H-L1 (S/H-R1, S/H-L2, S/H-R2) and the output buffer OB-L1 (OB-R1, OB-L2, OB-R2) form an analog signal receiving/holding section.

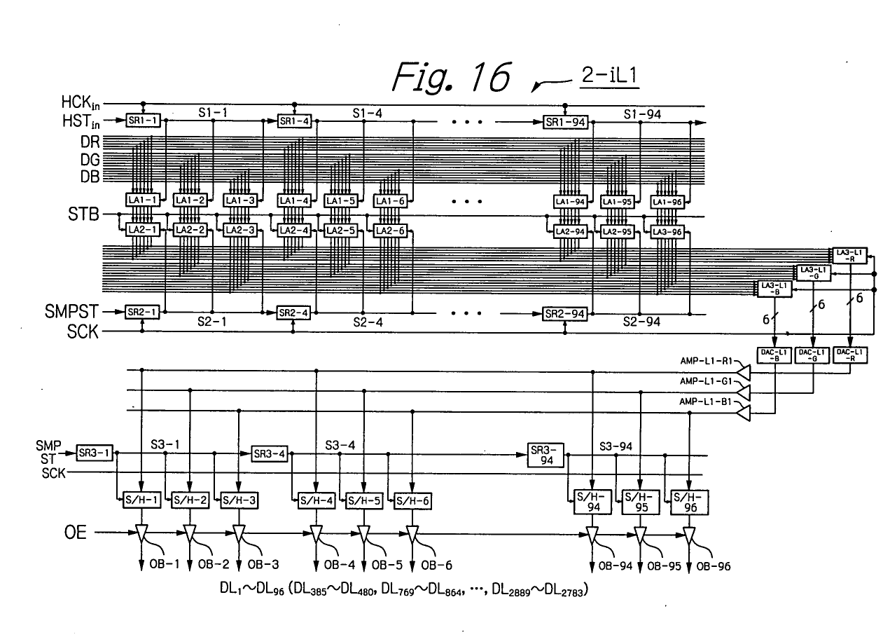

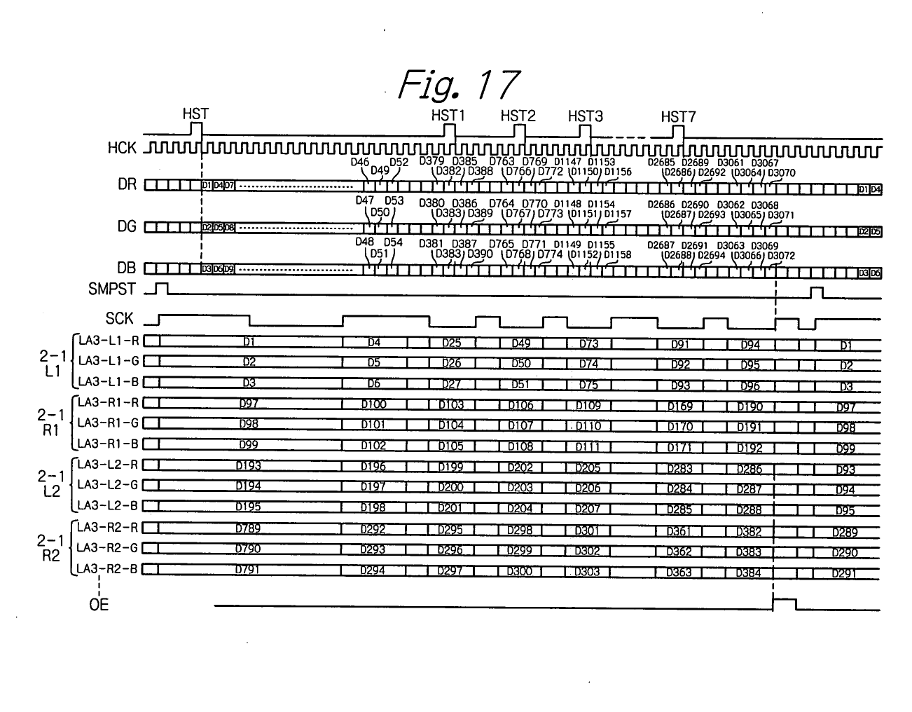

FIG. 16 is a detailed circuit diagram of the data line driver section 2-i of FIG. 15, and FIG. 17 is a timing diagram for explaining the operation of the data line driver section 2-i of FIG. 15 and the other data line driver sections.

Each element of the data line driver section 2-i of FIG. 15 is explained in detail next with reference to FIGS. 16 and 17.

The shift register circuit SR1-L1 shifts a horizontal start signal HSTᵢₙ from a controller such as the controller 4 of FIG. 5 in synchronization with a horizontal clock signal HCK from the controller, to generate latch signals S1-1, S1-4, . . . , S1-94. That is, as illustrated in FIG. 16, the shift register circuit SR1-L1 is constructed by 64 shift registers SR1-1, SR1-4, . . . , SR1-94. Similarly, the shift register circuit SR1-R1 generates latch signals S1-97, S1-100, . . . , S1-190 (not shown). Also, the shift register circuit SR1-L1 generates latch signals S1-193, S1-196, . . . , S1-286. Similarly, the shift register circuit SR1-R2 generates latch signals S1-289, S1-292, . . . , S1-382 (not shown) and also, a horizontal start signal HSTₒᵤₜ for the next stage data line driver section, if any.

The latch circuit LA1-L1 latches video signals (18 bits) formed by red data (DR) (6 bits), green data (DG) (6 bits) and blue data (DB) (6 bits) from the controller in synchronization with the latch signals S1-1, S1-4, . . . , S1-94. That is, as illustrated in FIG. 16, the latch circuit LA1-L1 is constructed by 96 latches LA1-1, LA1-2, . . . , LA1-96. Similarly, the LA1-R1 is constructed by 96 latches LA1-97, LA1-98, . . . , LA1-192 (not shown). Also, the latch circuit LA1-L2 is constructed by 96 latches LA1-193, LA1-194, . . . , LA1-288 (not shown). Similarly, the LA1-R1 is constructed by 96 latches LA1-289, LA1-290, . . . , LA1-284 (not shown).

The latch circuit LA2-L1 latches the digital video signals DR, DG and DB latched by the latch circuit LA1-L1 in synchronization with a strobe signal STB from the controller. Similarly, the latch circuit LA2-R1 latches the digital video signals DR, DG and DB latched by the latch circuit LA1-R1 in synchronization with the strobe signal STB from the controller. Also, the latch circuit LA2-L2 latches the digital video signals DR, DG and DB latched by the latch circuit LA1-L2 in synchronization with a strobe signal STB from the controller. Further, the latch circuit LA2-R2 latches the digital video signals DR, DG and DB latched by the latch circuit LA1-R2 in synchronization with the strobe signal STB from the controller.

On the other hand, the shift register circuit SR2-L1 shifts a start signal SMPST from the controller in synchronization with a clock signal SCK whose rate is thirty-two times smaller than that of the horizontal clock signal HCK, to generate latch signals S2-1, S2-4, . . . , S2-96. The clock signal SCK is also generated from the controller. That is, as illustrated in FIG. 16, the shift register circuit SR2-L1 is constructed by 32 shift registers SR2-1, SR2-4, . . . , SR2-94. Similarly, the shift register circuit SR2-R1 is constructed by 32 shift registers SR2-97, SR2-100, . . . , SR2-190 (not shown). Also, the shift register circuit SR2-L2 is constructed by 32 shift registers SR2-193, SR2-196, . . . , SR2-286. Further, the shift register circuit SR2-R2 is constructed by 32 shift registers SR2-289, SR2-292, . . . , SR2-382 (not shown).

As a result, the three data DR, DG and DB (6 bits×3) are read in synchronization with the latch signals S2-1, S2-4, . . . , S2-382, and are latched in the latch circuits LA3-L1, LA3-R1, LA3-L2 and LA3-R2 in synchronization with the clock signal SCK. That is, as illustrated in FIG. 16, the latch circuit LA3-L1 is constructed by three latches LA3-L1-R, LA3-L1-G and LA3-L1-B. Similarly, the latch circuit LA3-R1 is constructed by three latches LA3-R1-R, LA3-R1-G and LA3-R1-B (not shown). Also, the latch circuit LA3-L2 is constructed by three latches LA3-L2-R, LA3-L2-G and LA3-L2-B. Further, the latch circuit LA3-R2 is constructed by three latches LA3-R2-R, LA3-R2-G and LA3-R2-B (not shown).

As illustrated in FIG. 17, in the sub data line driver section 2-1L1, data D1 to D96 (6 bits) are sequentially latched in the latch circuit LA3-L1 during one horizontal scanning period (video signal period). Also, in the sub data line driver section 2-1R1, data D97 to D192 (6 bits) are sequentially latched in the latch circuit LA3-R during one horizontal scanning period (video signal period). Similarly, in the sub data line driver section 2-1L2, data D193 to D288 (6 bits) are sequentially latched in the latch circuit LA3-L2 during the same horizontal scanning period (video signal period). Also, in the sub data line driver section 2-1R2, data D289 to D384 (6 bits) are sequentially latched in the latch circuit LA3-R2 during the same horizontal scanning period (video signal period).

Again in FIG. 15, the three data DR, DG and DB (6 bits×3) latched in the latch circuits LA3-L1, LA3-R1, LA3-L2 and LA3-R2 are subject to D/A conversions in the D/A converters DAC-L1, DAC-R1, DAC-L2 and DAC-R2 to generate three analog video signals. That is, as illustrated in FIG. 16, the D/A converter DAC-L1 is constructed by D/A converter elements DAC-L1-R, DAC-L1-G and DAC-L1-B. Similarly, the D/A converter DAC-R1 is constructed by D/A converter elements DAC-R1-R, DAC-R1-G and DAC-R1-B (not shown). Also, the D/A converter DAC-L2 is constructed by D/A converter elements DAC-L2-R, DAC-L2-G and DAC-L2-B. Further, the D/A converter DAC-R2 is constructed by D/A converter elements DAC-R2-R, DAC-R2-G and DAC-R2-B (not shown).

The three analog video signals are supplied to the amplifier circuits AMP-L1, AMP-R1, AMP-L2 and AMP-R2 to substantially increase the speed of the D/A converter DAC-L1, DAC-R1, DAC-L2 and DAC-R2. That is, as illustrated in FIG. 16, the amplifier circuit AMP-L1 is constructed by three amplifiers AMP-L1-R, AMP-L1-G and AMP-L1-B. Similarly, the amplifier circuit AMP-R1 is constructed by three amplifiers AMP-R1-R, AMP-R1-G and AMP-R1-B (not shown). Also, the amplifier circuit AMP-L2 is constructed by three amplifiers AMP-L2-R, AMP-L2-G and AMP-L2-B. Further, the amplifier circuit AMP-R2 is constructed by three amplifiers AMP-R2-R, AMP-R2-G and AMP-R2-B (not shown).

Additionally, the shift register circuits SR3-L1, SR3-R1, SR3-L2 and SR3-R2 shift the start signal SMPST from the controller in synchronization with the clock signal SCK. That is, as illustrated in FIG. 16, the shift register circuit SR3-L1 is constructed by shift registers SR3-1, SR3-4, . . . , SR3-94. Similarly, the shift register circuit SR3-R1 is constructed by shift registers SR3-97, SR3-100, SR3-190 (not shown). Also, the shift register circuit SR3-L2 is constructed by shift registers SR3-193, SR3-197, . . . , SR3-286. Further, the shift register circuit SR3-R2 is constructed by shift registers SR3-289, SR3-292, . . . , SR3-382 (not shown).

The three analog video signals are sequentially sampled in the sample/hold circuits S/H-L1, S/H-R1, S/H-L2 and S/H-R2 in synchronization with the latch signals S3-1, S3-4, . . . , S3-382. That is, as illustrated in FIG. 16, the sample/hold circuit S/H-L1 is constructed by 96 sample/hold elements S/H-1, S/H-2, . . . , S/H-96. Similarly, the sample/hold circuit S/H-R1 is constructed by 96 sample/hold elements S/H-97, S/H-98, . . . , S/H-192 (not shown). Also, the sample/hold circuit S/H-L2 is constructed by 96 sample/hold elements S/H-193, S/H-194, . . . , S/H-288 (not shown). Further, the sample/hold circuit S/H-R2 is constructed by 96 sample/hold elements S/H-289, S/H-290, . . . , S/H-384 (not shown).

The analog video data in the sample/hold circuits S/H-L1, S/H-R1, H/S-L2 and H/S-R2 are supplied to the output buffers OB-L1, OB-R1, OB-L2 and OB-R2 which supplies the analog data to the data lines DL₁, DL₂, . . . , DL₃₈₄. That is, as illustrated in FIG. 16, the sample/hold circuit S/H-L1 is constructed by 96 sample/hold sections S/H-1, S/H-2, . . . , S/H-96. Similarly, the sample/hold circuit S/H-R1 is constructed by 96 sample/hold sections S/H-97, S/H-98, . . . , S/H-192 (not shown). Also, the sample/hold circuit S/H-L2 is constructed by 96 sample/hold sections S/H-193, S/H-194, . . . , S/H-288. Further, the sample/hold circuit S/H-R2 is constructed by 96 sample/hold sections S/H-289, S/H-290, . . . , S/H-384 (not shown).

The analog video data sampled in the sample/hold circuit S/H-L1, S/H-R1, S/H-L2 and S/H-R2 are output by the output buffers OB-L1, OB-R1, OB-L2 and OB-R2 in synchronization with the output enable signal OE to the data lines DL₁, DL₂, . . . , DL₃₈₄ (DL₃₈₅, DL₃₈₆, . . . , DL₇₆₈; DL₇₆₉, DL₇₇₀, . . . , DL₁₁₅₂; . . . ; DL₂₆₈₉, DL₂₆₉₀, . . . , DL₃₀₇₂). That is, as illustrated in FIG. 16, the output buffer OB-L1 is constructed by 96 buffers OB-1, OB-2, . . . , OB-96. Similarly, the output buffer OB-R1 is constructed by 96 buffers OB-97, OB-98, . . . , OB-192 (not shown). Also, the output buffer OB-L2 is constructed by 96 buffers OB-193, OB-194, . . . , OB-288 (not shown). Further, the output buffer OB-R2 is constructed by 96 buffers OB-289, OB-290, . . . , OB-384 (not shown).

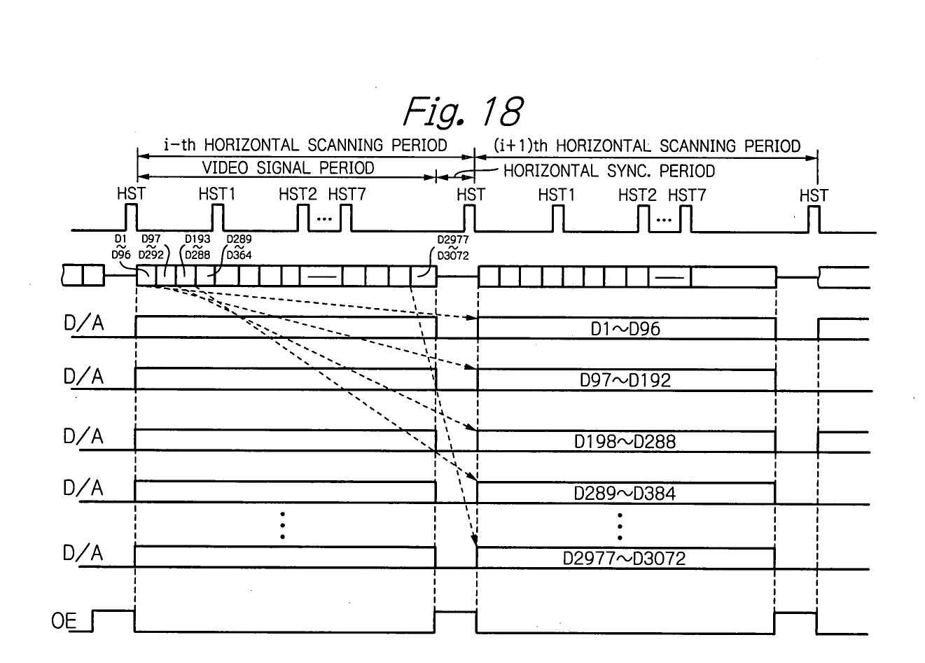

If the configuration of the data line driver section of FIG. 15 is applied to each of the data line driver sections 2-1, 2-2, . . . , 2-8 of FIG. 5, the operation of the data line driver sections 2-1, 2-2, . . . , 2-8 is shown in FIG. 18, where data of two scanning lines is subjected to a pipeline processing. That is, as illustrated in FIG. 18, D/A conversion performed upon the digital video data D1˜D96 is carried out within T. Also, D/A conversion performed upon the digital video data D97˜D192 is carried out within T. Further, D/A conversion performed upon the digital video data D198˜D288 is carried out within T. Additionally, D/A conversion performed upon the digital video data D289˜D384 is carried out within T. Further, D/A conversion performed upon the digital video data D2977˜D3072 is carried out within T. Therefore, even when the number of cascaded data line driver sections is increased, the sampling period corresponding to the D/A conversion period need not to be decreased, i.e., the sampling period corresponding to the D/A conversion period can be four times or larger than the period of the horizontal clock signal HCK, so that the sampling period can be even longer.

Although the above-described embodiments relate to LCD apparatuses, the present invention can be applied to other plane display apparatuses such as organic EL display apparatuses.

As explained hereinabove, the more the number of cascaded data line driver sections, the longer the sampling period. Also, when each data line driver section is further divided into a plurality of cascaded sub sections having the same configuration, the sampling period can be further increased.

1. A data line driver for driving N (N=2, 3, . . . ) data lines of a display apparatus including cascaded M (M=2, 3, . . . ) data line driver sections, each of said data line driver sections comprising:
a digital signal receiving and holding section adapted to receive and hold N/M digital video signals in synchronization with a first clock signal;
a digital/analog converter adapted to perform a digital/analog conversion upon said N/M digital video signals in synchronization with a second clock signal whose rate is smaller than that of said first clock signal, to generate N/M analog video signals; and
an analog video signal receiving and holding section adapted to receive and hold said N/M analog video signals.

2. The data line driver as set forth in claim 1, wherein said digital signal receiving and holding section comprises:
a first transfer circuit adapted to shift a first start signal in synchronization with said first clock signal to generate a first latch signal;
a first digital signal storing circuit adapted to latch said digital video signals in synchronization with said first latch signal;
a second digital signal storing circuit adapted to latch all said digital video signals in said first digital signal storing circuit in synchronization with a strobe signal; and
a third digital signal storing circuit adapted to sequentially latch respective parts of said digital video signals latched in said second digital signal storing circuit in synchronization with said second clock signal.

3. The data line driver as set forth in claim 2, wherein said digital signal receiving and holding section further comprises a second transfer circuit adapted to shift a second start signal in synchronization with said second clock signal to generate a second latch signal, so that said parts of said digital video signals are sequentially transferred from said second digital signal storing circuit to said third digital signal storing circuit in synchronization with said second latch signal.

4. The data line driver as set forth in claim 1, wherein said analog signal receiving and holding section comprises:
a sample/hold circuit adapted to sample and hold said analog video signals of said digital/analog converter in synchronization with said second clock signal; and
an output buffer adapted to output said analog video signals of said sample/hold circuit in synchronization with an output enable signal.

5. The data line driver as set forth in claim 4, wherein said analog signal receiving and holding section further comprises a third transfer circuit adapted to shift a third start signal in synchronization with said second clock signal to generate a third latch signal, so that said sample/hold circuit samples said analog video signals of said digital/analog converter in synchronization with said third latch signal.

6. The data line driver as set forth in claim 1, wherein each of said data line driver sections further comprises an amplifier circuit adapted to amplify said analog video signals.

7. A data line driver for driving N (N=2, 3, . . . ) data lines of a display apparatus including cascaded M (M=2, 3, . . . ) data line driver sections, each of said data line driver sections further including cascaded L (L=2, 3, . . . ) sub data line drivers, each of said sub data line driver sections comprising:
a digital signal receiving and holding section adapted to receive and hold N/(M*L) digital video signals in synchronization with a first clock signal;
a digital/analog converter adapted to perform a digital/analog conversion upon said N/(M* L) digital video signals in synchronization with a second clock signal whose rate is smaller than that of said first clock signal, to generate N/(M*L) analog video signals; and
an analog video signal receiving and holding section adapted to receive and hold said N/(M* L) analog video signals.

8. The data line driver as set forth in claim 7, wherein said digital signal receiving and holding section comprises:
a first transfer circuit adapted to shift a first start signal in synchronization with said first clock signal to generate a first latch signal;
a first digital signal storing circuit adapted to latch said digital video signals in synchronization with said first latch signal;
a second digital signal storing circuit adapted to latch all said digital video signals in said first digital signal storing circuit in synchronization with a strobe signal; and
a third digital signal storing circuit adapted to sequentially latch respective parts of said digital video signals latched in said second digital signal storing circuit in synchronization with said second clock signal.

9. The data line driver as set forth in claim 8, wherein said digital signal receiving and holding section further comprises a second transfer circuit adapted to shift a second start signal in synchronization with said second clock signal to generate a second latch signal, so that said parts of said digital video signals are sequentially transferred from said second digital signal storing circuit to said third digital signal storing circuit in synchronization with said second latch signal.

10. The data line driver as set forth in claim 7, wherein said analog signal receiving and holding section comprises:
a sample/hold circuit adapted to sample and hold said analog video signals of said digital/analog converter in synchronization with said second clock signal; and
an output buffer adapted to output said analog video signals of said sample/hold circuit in synchronization with an output enable signal.

11. The data line driver as set forth in claim 10, wherein said analog signal receiving and holding section further comprises a third transfer circuit adapted to shift a third start signal in synchronization with said second clock signal to generate a third latch signal, so that said sample/hold circuit samples said analog video signals of said digital/analog converter in synchronization with said third latch signal.

12. The data line driver as set forth in claim 7, wherein each of said data line driver sections further comprises an amplifier circuit adapted to amplify said analog video signals.

13. A method for driving a data line driver for driving N (N=2, 3, . . . ) data lines of a display apparatus including cascaded M (M=2, 3, . . . ) data line driver sections, comprising:
receiving and holding N/M digital video signals by each of said data line driver sections in synchronization with a first clock signal;
performing a digital/analog conversion upon said N/M digital video signals by each of said data line driver sections in synchronization with a second clock signal whose rate is smaller than that of said first clock signal, to generate N/M analog video signals; and
receiving and holding said N/M analog video signals by each of said data line driver sections.

14. A method for driving a data line driver for driving N (N=2, 3, . . . ) data lines of a display apparatus including cascaded M (M=2, 3, . . . ) data line driver sections, each of said data line driver sections further including cascaded L (L=2, 3, . . . ) sub data line drivers comprising:
receiving and holding N/M digital video signals by each of said sub data line driver sections in synchronization with a first clock signal;
performing a digital/analog conversion upon said N/M digital video signals by each of said sub data line driver sections in synchronization with a second clock signal whose rate is smaller than that of said first clock signal, to generate N/M analog video signals; and
receiving and holding said N/M analog video signals by each of said sub data line driver sections.
